(19) United States
(12) Patent Application Publication
(10) Pub. No.: US 2012/0159517 A1
(43) Pub. Date: Jun. 21, 2012

(54) MANAGING A MODEL-BASED DISTRIBUTED APPLICATION

(75) Inventors: Andy Shen, Bellevue, WA (US); Leo S. Vannelli, III, North Bend, WA (US); Vikram Desai, Redmond, WA (US); Vladimir Pogrebinsky, Sammamish, WA (US); Andrew R. Luty, Redmond, WA (US); Gilles C.J.A. Zunino, Kirkland, WA (US); Karandeep Y. Singh Anand, Kirkland, WA (US)

(73) Assignee: Microsoft Corporation, Redmond, WA (US)

(21) Appl. No.: 12/973,099

(22) Filed: Dec. 20, 2010

(51) Int. Cl. G06F 9/46

(52) U.S. Cl. 719/318

(57) ABSTRACT

A method for managing a model-based distributed application includes accessing a declarative application model describing an application intent for each of multiple application dimensions, and deploying a model-based distributed application in accordance with the declarative application model. Events associated with the deployed application are received. An observed state of the deployed application is determined for each of the multiple dimensions based on the received events. Operation of the deployed application is modified when the observed state for any one of the multiple dimensions deviates from the application intent for that dimension.

### BACKGROUND

In general, distributed application programs comprise components that are executed over several different hardware components, often on different computer systems in a network or tiered environment. With distributed application programs, the different computer systems may communicate various processing results to each other over a network. Along these lines, an organization will typically employ a distributed application server to manage several different distributed application programs over many different computer systems. For example, a user might employ one distributed application server to manage the operations of an e-commerce application program that is executed on one set of different computer systems. The user might also use the distributed application server to manage execution of customer management application programs on the same or even a different set of computer systems.

Each corresponding distributed application managed through the distributed application server can, in turn, have several different modules and components that are executed on still other different computer systems. One can appreciate, therefore, that while this ability to combine processing power through several different computer systems can be an advantage, there are various complexities associated with distributing application program modules. For example, a distributed application server may need to run distributed applications optimally on the available resources, and take into account changing demand patterns and resource availability.

The very distributed nature of business applications and variety of their implementations creates a challenge to consistently and efficiently monitor and manage such applications. The challenge is due at least in part to diversity of implementation technologies composed into a distributed application program. That is, diverse parts of a distributed application program have to behave coherently and reliably. Typically, different parts of a distributed application program are individually and manually made to work together. For example, a user or system administrator creates text documents that describe how and when to deploy and activate parts of an application and what to do when failures occur. Accordingly, it is then commonly a manual task to act on the application lifecycle described in these text documents.

Unfortunately, conventional distributed application servers are typically ill-equipped (or not equipped at all) to automatically monitor, manage and adjust to all of the different complexities associated with a distributed application. Various techniques for automated monitoring of distributed applications have been used to reduce, at least to some extent, the level of human interaction that is required to fix undesirable distributed application behaviors. However, these monitoring techniques suffer from a variety of inefficiencies.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the chinned subject matter.

A problem addressed herein is to provide a system and method for monitoring and managing distributed applications, including monitoring and managing software lifecycle, and automatically managing and adjusting operations of distributed application programs, without the problems and inefficiencies of prior approaches.

One embodiment is directed to a method for managing a model-based distributed application. The method includes accessing, a declarative application model describing an application intent for each of multiple application dimensions, and deploying a model-based distributed application in accordance with the declarative application model. Events associated with the deployed application are received. An observed state of the deployed application is determined for each of the multiple dimensions based on the received events. Operation of the deployed application is modified when the observed state for any one of the multiple dimensions deviates from the application intent for that dimension.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated, as they become better understood by reference to the following detailed description. The elements of the drawings are not necessarily to scale relative to each other. Like reference numerals designate corresponding similar parts.

FIG. 1 is a diagram illustrating a computing environment suitable for implementing aspects of a system for monitoring and managing distributed applications according to one embodiment.

FIG. 2 is a diagram illustrating a distributed application according to one embodiment.

FIG. 3 is a block diagram illustrating a computer architecture that facilitates monitoring and managing distributed applications according to one embodiment.

FIG. 4 is a block diagram illustrating a computer architecture that facilitates monitoring and managing distributed applications according to another embodiment.

FIG. 5 is a flow diagram illustrating a method for monitoring a model-based distributed application according to one embodiment.

FIG. 6 is a flow diagram illustrating a method for monitoring a model-based distributed application according to another embodiment.

FIG. 7 is a flow diagram illustrating a method for managing a model-based distributed application according to one embodiment.

FIG. 8 is a flow diagram illustrating a method for managing a model-based distributed application according to another embodiment.

### DETAILED DESCRIPTION

In the following Detailed Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that features of the various exemplary embodiments described herein may be combined with each other, unless specifically noted otherwise.

Some embodiments are directed to systems and methods for performing requested commands for model-based distributed applications. Other embodiments are directed to systems and methods for monitoring and managing distributed applications, including monitoring and managing software lifecycle, and automatically managing and adjusting operations of distributed application programs through a distributed application program server. Based on declarative models and knowledge of their interpretation, some embodiments facilitate lifecycle monitoring and management for model-based software applications. Model-based error handling and error recovery mechanisms are used in some embodiments to correct any identified errors. In some embodiments, systems and methods are provided for visualizing key performance indicators for model-based applications.

Accordingly, and as will be understood more fully from the following specification and claims, embodiments disclosed herein can provide a number of advantages, effectively through automated, yet high-level management. For example, a user (e.g., server/application administrator) can create high-level instructions in the form of declarative models, which effectively state various generalized intents regarding one or more operations and/or policies of operation in a distributed application program. These generalized intents of the declarative models can then be implemented through specific commands in various application containers or host environments, which, during or after execution, can also be coordinated with various event streams that reflect distributed application program behavior.

In particular, and as will also be discussed more fully herein, these event streams can be used in conjunction with the declarative models to reason about causes of behavior in the distributed application systems, and operational data regarding the real world can be logically joined with data in the declarative models. This joined data can then be used to plan changes and actions on declarative models based on causes and trends of behavior of distributed systems, and thus automatically adjust distributed application program behavior on an ongoing basis.

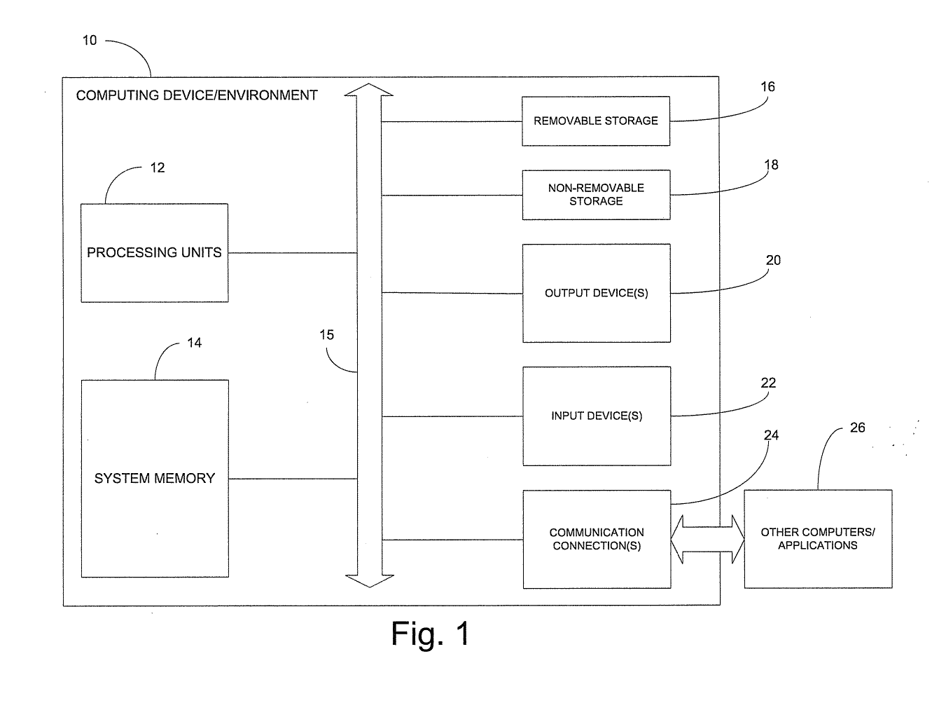

FIG. 1 is a diagram illustrating a computing environment 10 suitable for implementing aspects of a system for monitoring and managing distributed applications according to one embodiment. In the illustrated embodiment, the computing system or computing device 10 includes a plurality of processing units 12 and system memory 14. Depending on the exact configuration and type of computing device, memory 14 may be volatile (such as RAM), non-volatile (such as ROM, flash memory, etc.), or some combination of the two.

Computing device 10 may also have additional features/functionality. For example, computing device 10 may also include additional storage (removable and/or non-removable) including, but not limited to, magnetic or optical disks or tape. Such additional storage is illustrated in FIG. 1 by removable storage 16 and non-removable storage 18. Computer storage media includes volatile and nonvolatile, removable and non-removable media implemented in any suitable method or technology for storage of information such as computer readable instructions, data structures, program modules or other data. Memory 14, removable storage 16 and non-removable storage 18 are all examples of computer storage media (e.g., computer-readable storage media storing computer-executable instructions that when executed by at least one processor cause the at least one processor to perform a method). Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by computing device 10. Any such computer storage media may be part of computing device 10.

The various elements of computing device 10 are communicatively coupled together via one or more communication links 15. Computing device 10 also includes one or more communication connections 24 that allow computing device 10 to communicate with other computers/applications 26. Computing device 10 may also include input device(s) 22, such as keyboard, pointing device (e.g., mouse), pen, voice input device, touch input device, etc. Computing device 10 may also include output device(s) 20, such as a display, speakers, printer, etc.

FIG. 1 and the above discussion are intended to provide a brief general description of a suitable computing environment, in which one or more embodiments may be implemented. It should be understood, however, that handheld, portable, and other computing devices of all kinds are contemplated for use. While a general purpose computer is described above, this is but one example, and embodiments may he implemented using only a thin client having network server interoperability and interaction. Thus, embodiments be implemented in an environment of networked hosted services in which very little or minimal client resources are implicated, e.g., a networked environment in which the client device serves as a browser or interface to the World Wide Web.

Although not required, embodiments can be implemented via an application programming interface (API), for use by a developer, and/or included within the network browsing software Which will he described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that embodiments may be implemented with other computer system configurations. Other well known computing systems, environments, and/or configurations that may be suitable for use include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. Embodiments may also be implemented in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 10 in Which the embodiments may be implemented, although as made clear above, the computing system environment 10 is only one example of a suitable computing environment and is not intended to suggest any limitation as to the scope of use or functionality of the embodiments. Neither should the computing environment 10 be interpreted as having any dependency or requirement relating to any one or combination of components illustrated in the exemplary operating environment 10.

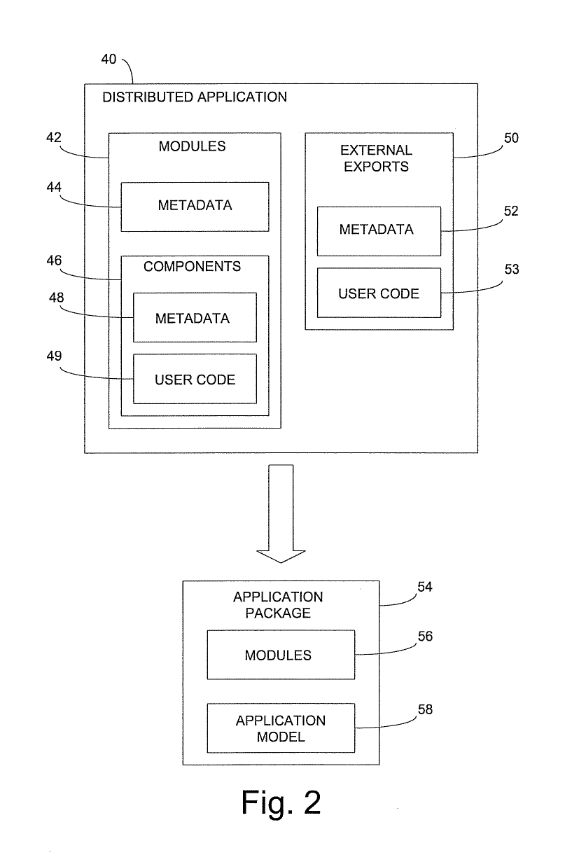

FIG. 2 is a diagram illustrating a distributed application 40 (or component application) according to one embodiment. Distributed application 40 includes modules 42 and external exports 50. Each module 42 includes metadata 44 and one or more components 46. Components 46 include metadata 48 and user code 49. External exports 50 include metadata 52 and user code 53. Metadata 44, 48, and 52 include versioning information, a description of the configuration data the code uses, resources the code may need to run, dependencies, and other information. A dependency refers to the requirement of one software entity for a second software entity to be available. A software item may have a dependency on one or more other software items.

Components 46 encapsulate user code 49, and are designed to operate together to perform a specific function or group of functions. External exports 50 allow applications to consume web services external to the application through user code 53. Distributed application 40 may be provided in the form of an application package 54, which includes modules 56 that contain all of the data (e.g., executable code, content, and configuration information) for an application, as well as an application model 58 (also referred to as an application manifest or application definition), which includes the metadata 44, 48, and 52, and defines the developer's intent for the application 40. Developers capture their intent by adding modules 42 and placing one or more components 46 in them. Example of intent captured by the application model includes but is not limited to: “there is a web page named ‘default.aspx’. This web page calls a web service using the http binding. The contract used is ICatalogService.”

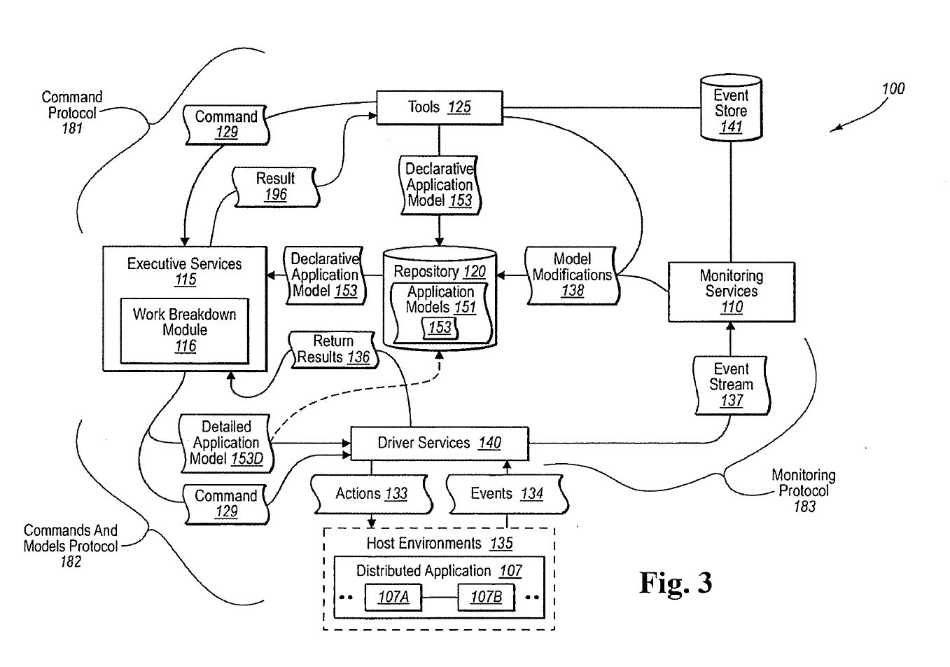

FIG. 3 is a block diagram illustrating a computer system architecture 100 that facilitates monitoring and managing distributed applications according to one embodiment. Computer architecture 100 includes tools 125, repository 120, executive services 115, driver services 140, host environments 135, monitoring services 110, and events store 141. Each of the depicted components can be connected to one another over a network, such as, for example, a Local Area Network (“LAN”), a Wide Area Network (“WAN”), and even the Internet. Accordingly, each of the depicted components as well as any other connected components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

As depicted, tools 125 can be used to write and modify (e.g., through model modifications 138) declarative models for applications and store declarative models, such as, for example, declarative application model 153, in repository 120. Declarative models are used to describe the structure and behavior of real-world running (deployable) applications, and to describe the structure and behavior of other activities related to applications. Thus, a user (e.g., distributed application program developer) can use one or more of tools 125 to create declarative application model 153.

Generally, declarative models include one or more sets of high-level declarations expressing application intent for a distributed application. Thus, the high-level declarations generally describe operations and/or behaviors of one or more modules in the distributed application program. However, the high-level declarations do not necessarily describe implementation steps required to deploy a distributed application having the particular operations/behaviors (although they can if appropriate). For example, declarative application model 153 can express the generalized intent of a workflow, including, for example, that a first Web service be connected to a database. However, declarative application model 153 does not necessarily describe how (e.g., protocol) nor where (e.g., address) the Web service and database are to he connected to one another. In fact, how and where is determined based on which computer systems the database and the Web service are deployed.

To implement a command for an application based on a declarative model, the declarative model can be sent to executive services 115. Executive services 115 can refine the declarative model until there are no ambiguities and the details are sufficient for drivers to consume. Thus, executive services 115 can receive and refine declarative application model 153 so that declarative application model 153 can be translated by driver services 140 (e.g., by one or more technology, specific drivers) into a deployable application.

Tools 125 and executive services 115 can exchange commands for model-based applications and corresponding results using command protocol 181. Command protocol 181 defines how to request that a command performed on a model by passing a reference to the model. For example, tools 125 can send command 129 to executive services 115 to perform a command for a model based application. Executive services 115 can report result 196 back to tools 125 to indicate the results and/or progress of command 129. Command protocol 181 can also define how to check the status of a command during its execution and after completion or failure. Command protocol 181 can also be used to query error information (e.g., from repository 120) if a command fails.

Accordingly, command protocol 181 can be used to request performance of software lifecycle commands, such as, for example, create, verify, re-verify, clean, deploy, undeploy, check, fix, update, monitor, start, stop, etc., on an application model by passing a reference to the application model. Performance of lifecycle commands can result in corresponding operations including creating, verifying, re-verifying, cleaning, deploying, undeploying, checking, fixing, updating, monitoring, starting and stopping distributed model-based applications respectively.

In general, “refining” a declarative model can include some type of work breakdown structure, such as, for example, progressive elaboration, so that the declarative model instructions are sufficiently complete for translation by drivers 142. Since declarative models can be written relatively loosely by a human user (i.e., containing generalized intent instructions or requests), there may be different degrees or extents to which executive services 115 modifies or supplements a declarative model for a deployable application. Work breakdown module 116 can implement a work breakdown structure algorithm, such as, for example, a progressive elaboration algorithm, to determine when an appropriate granularity has been reached and instructions are sufficient for driver services 140.

Executive services 115 can also account for dependencies and constraints included in a declarative model. For example, executive services 115 can be configured to refine declarative application model 153 based on semantics of dependencies between elements in the declarative application model 153 (e.g., one web service connected to another). Thus, executive services 115 and work breakdown module 116 can interoperate to output detailed declarative application model 153D that provides driver services 140 with sufficient information to realize distributed application 107.

In additional or alternative implementations, executive services 115 can also be configured to refine the declarative application model 153 based on some other contextual awareness. For example, executive services 115 can refine declarative application model based on information about the inventory of host environments 135 that may be available in the datacenter where distributed application 107 is to be deployed. Executive services 115 can reflect contextual awareness information in detailed declarative application model 153D.

In addition, executive services 115 can be configured to fill in missing data regarding computer system assignments. For example, executive services 115 can identify a number of different distributed application program modules in declarative application model 153 that have no requirement for specific computer system addresses or operating requirements. Thus, executive services 115 can assign distributed application program modules to an available host environment on a computer system. Executive services 115 can reason about the best way to fill in data in a refined declarative application model 153. For example, as previously described, executive services 115 may determine and decide which transport to use for an endpoint based on proximity of connection, or determine and decide how to allocate distributed application program modules based on factors appropriate for handling, expected spikes in demand. Executive services 115 can then record missing data in detailed declarative application model 153D (or segment thereof).

In addition or alternative implementations, executive services 115 can be configured to compute dependent data in the declarative application model 153. For example, executive services 115 can compute dependent data based on an assignment of distributed application program modules to host environments on computer systems. Thus, executive services 115 can calculate URI addresses on the endpoints, and propagate the corresponding URI addresses from provider endpoints to consumer endpoints. In addition, executive services 115 may evaluate constraints in the declarative application model 153. For example, the executive services 115 can be configured to check to see if two distributed application program modules can actually be assigned to the same machine, and if not, executive services 115 can refine detailed declarative application model 153D to accommodate this requirement.

Accordingly, after adding appropriate data (or otherwise modifying/refining) to declarative application model 153 (to create detailed declarative application model 153D), executive services 115 can finalize the refined detailed declarative application model 153D so that it can be translated by platform-specific drivers included in driver services 140. To finalize or complete the detailed declarative application model 153D, executive services 115 can, for example, partition a declarative application model into segments that can be targeted by any one or more platform-specific drivers. Thus, executive services 115 can tag each declarative application model (or segment thereof) with its target driver (e.g., the address or the ID of a platform-specific driver).

Furthermore, executive services 115 can verify that a detailed application model (e.g., 153D) can actually he translated by one or more platform-specific drivers, and, if so, pass the detailed application model (or segment thereof) to a particular platform-specific driver for translation. For example, executive services 115 can be configured to tag portions of detailed declarative application model 153D with labels indicating an intended implementation for portions of detailed declarative application model 153D. An intended implementation can indicate a framework and/or a host, such as, for example, WCF-IIS, Aspx-IIS, SQL, Axis-Tomcat, WF/WCF-WAS, etc.

After refining a model, executive services 115 can forward the model to driver services 140 or store the refined model back in repository 120 for later use. Thus, executive services 115 can forward detailed declarative application model 153D to driver services 140 or store detailed declarative application model 153D in repository 120. When detailed declarative application model 153D is stored in repository 120, it can be subsequently provided to driver services 140 without further refinements.

Commands and models protocol 182 defines how to request a command to be performed on a model and offers model data to be requested back from a caller. Executive services 115 and driver services 140 can perform requested commands for model-based applications using commands and models protocol 182. For example, executive service 115 can send command 129 and a reference to detailed declarative application model 153D to driver services 140. Driver services 140 can then request detailed declarative application model 153D and other resources from executive services 115 to implement command 129.

Commands and models protocol 182 also defines how command progress and error information are reported back to the caller and how to request that commands be cancelled. For example, driver services 140 can report return result 136 back to executive service 115 to indicate the results and/or progress of command 129.

Driver services 140 can then take actions (e.g., actions 133) to implement an operation for a distributed application based on detailed declarative application model 153D. Driver services 140 interoperate with one or more (e.g., platform-specific) drivers to translate detailed application model 153D (or declarative application model 153) into one or more (e.g., platform-specific) actions 133. Actions 133 can be used to realize an operation for a model-based application.

Thus, distributed application 107 can be implemented in host environments 135. Each application part, for example, 107A, 107B, etc., can be implemented in a separate host environment and connected to other application parts via correspondingly configured endpoints.

Accordingly, the generalized intent of declarative application model 153, as refined by executive services 115 and implemented by drivers accessible to driver services 140, is expressed in one or more of host environments 135. For example, when the general intent of declarative application model is to connect two Web services, specifics of connecting the first and second Web services can vary depending on the platform and/or operating environment. When deployed within the same data center, Web service endpoints can be configured to connect using TCP. On the other hand, when the first and second Web services are on opposite sides of a firewall, the Web service endpoints can be configured to connect using a relay connection.

To implement a model-based command, tools 125 can send a command (e.g., command 129) to executive services 115. Generally, a command represents an operation (e.g., a lifecycle state transition) to be performed on a model. Operations include creating, verifying, re-verifying, cleaning, deploying, undeploying, checking, fixing, updating, monitoring, starting and stopping distributed applications based on corresponding declarative models.

In response to the command (e.g., command 129), executive services 115 can access an appropriate model (e.g., declarative application model 153). Executive services 115 can then submit the command (e.g., command 129) and a refined version of the appropriate model (e.g., detailed declarative application model 153D) to driver services 140. Driver services 140 can use appropriate drivers to implement a represented operation through actions (e.g., actions 133). The results (e.g., result 196) of implementing the operation can be returned to tools 125.

Distributed application programs can provide operational information about execution. For example, during execution, distributed application 107 can emit events 134 indicative of events (e.g., execution or performance issues) that have occurred at the distributed application. Events 134 are data records about real-world occurrences, such as module started, stopped or its operation failed. In some embodiments, events are pushed to driver services 140. Alternatively or in combination with pushed event data, event data can he accumulated within the scope of application parts 107A, 107B, etc., host environments 135, and other systems on a computer (e.g., Windows Performance Counters). Driver services 140 can poll for accumulated event data periodically, and then forward events 134 in event stream 137 to monitoring services 110.

Monitoring protocol 183 defines how to send events for processing. Driver services 140 and monitoring service 110 can exchange event streams using monitoring protocol 183. In one implementation, driver services 140 collect emitted events and send out event stream 137 to monitoring services 110 on a continuous, ongoing basis, while, in other implementations, event stream 137 is sent out on a scheduled basis (e.g., based on a schedule setup by a corresponding platform-specific driver).

Generally, monitoring services 110 can perform analysis, tuning, and/or other appropriate model modification. Monitoring services 110 process events, such as, for example, event stream 137, received from driver services 140. Monitoring service 110 aggregates, correlates, and otherwise filters data from event stream 137 to identify interesting trends and behaviors of distributed application 107. Monitoring service 110 can also automatically adjust the intent of declarative application model 153 as appropriate, based on identified trends. For example, monitoring service 110 can send model modifications 138 to repository 120 to adjust the intent of declarative application model 153. An adjusted intent can reduce the number of messages processed per second at a computer system if the computer system is running low on system memory, redeploy a distributed application on another machine if the currently assigned machine is rebooting too frequently, etc. Monitoring service 110 can store any results in event store 141.

In some embodiments, monitoring service 110 normalizes event stream 137, and computes operational data. Generally, the operational data includes virtually any type of operational information regarding the operation and/or behavior of any module or component of distributed application 107. For example, monitoring service 110 can compute the number of requests served per hour, the average response times, etc. for distributed application 107 (from event stream 137) and include the results of these computations in the operational data.

To create useful operational data, monitoring service 110 can compare the event stream 137 with the intent of a corresponding declarative model to compute and create useful operational data. In one embodiment, application models 151 include a declarative observation model that describes how events (e.g., from event stream 137) are to be aggregated and processed to produce appropriate operational data. In at least one implementation, monitoring service 110 performs join-like filtering of event streams that include real world events with intent information described by a particular declarative model. Accordingly, operational data can include primarily data, that is relevant and aggregated to the level of describing a running distributed application (and corresponding modules) and systems around it. For example, monitoring service 110 can compare event stream 137 to the intent of declarative application model 153 to compute operational data for distributed application 107 (a deployed application based on declarative application model 153). Monitoring service 110 can then write the operational data to repository 120.

In one embodiment, monitoring service 110 includes an expert system that is configured to detect trends, pathologies, and their causes in the behavior of running applications (e.g., acceleration of reboot rates cause by a memory leak). Monitoring service 110 can access a declarative model and corresponding operational data and logically join information from the operational data to the declarative model intent. Based on the joining, monitoring service 110 can determine if a distributed application is operating as intended.

For example, monitoring service 110 can access declarative application model 153 and corresponding operational data and logically join information from the operational data to the intent of declarative application model 153. Based on the joining, monitoring service 110 can determine if distributed application 107 is operating as intended.

Upon detecting trends, pathologies, etc, and their causes in the behavior of running applications, monitoring service 110 can pass this information to an expert system within monitoring service 110 that decides how to adjust the intent of declarative models based on behavioral, trend-based, or otherwise environmental actions and/or causes. For example, monitoring service 110 may decide upon review of the information to roil back a recent change (e.g., that caused a particular server to reboot very frequently) to a distributed application program.

In order to make determinations about whether or to what extent to adjust the intent of a distributed application program, monitoring service 110 can employ any number of tools. For example, monitoring service 110 can apply statistical inferencing and constraint-based optimization techniques. Monitoring service 110 can also compare potential decisions on a declarative model (e.g., a possible update thereto) to prior decisions made for a declarative model (e.g., a previous update thereto), and measure success rates continuously over time against a Bayesian distribution. Thus, monitoring service 110 can directly influence operations in a distributed application program at least in part by adjusting the intent of the corresponding declarative model.

For example, monitoring service 110 can identify inappropriate behavior in distributed application 107. Accordingly, monitoring service 110 can send model modifications 138 to repository 120 to modify the intent of declarative application model 153. For example, it may he that modules of distributed application 107 are causing a particular computer system to restart or reboot frequently. Thus, monitoring, service 110 can send model modifications 138 to roll-back a recent change to declarative application model 153 and eliminate possible memory leaks or change other intended behavior to increase the stability of the computer system. When model modifications 138 are saved, executive services 115 can access the modifications and redeploy a new distributed application to implement the adjusted intent.

Accordingly, in some embodiments, executive services 115, drivers services 140, and monitoring services 110 interoperate to implement a software lifecycle management system. Executive services 115 implement command and control function of the software lifecycle management system applying software lifecycle models to application models. Driver services 140 translate declarative models into actions to configure and control model-based applications in corresponding host environments. Monitoring services 110 aggregate and correlate events that can used to reason on the lifecycle of model-based applications.

Tools 125 facilitate software lifecycle management by permitting users to design applications and describe them in models. For example, tools 125 can read, visualize, and write model data in repository 120. Tools 125 can also configure applications by adding properties to models and allocating application parts to hosts. Tools 125 can also deploy, start, and stop applications based on models in repository 120.

Tools 125 can monitor applications by reporting on health and behavior of application parts and their hosts. For example, tools 125 can monitor applications running in host environments 135, such as, for example, distributed application 107. Tools 125 can also analyze running applications by studying history of health, performance and behavior and projecting trends. Tools 125 can also, depending on monitoring and analytical indications, optimize applications by transitioning applications to any of the lifecycle states or by changing declarative application models in the repository 120.

Tools 125 can locate events that contain information regarding the runtime behavior of applications, and can be used to visualize information from event store 141 (e.g. list key performance indicators computed based on events coming from a given application). In some embodiments, tools 125 receive application model 153 and corresponding event data and calculate one or more key performance indicators for distributed application 107.

Accordingly, some embodiments include a system for monitoring and managing the lifecycle of software that includes one or more tools, one or more executive services, a repository, one or more driver services, and one or more monitoring services.

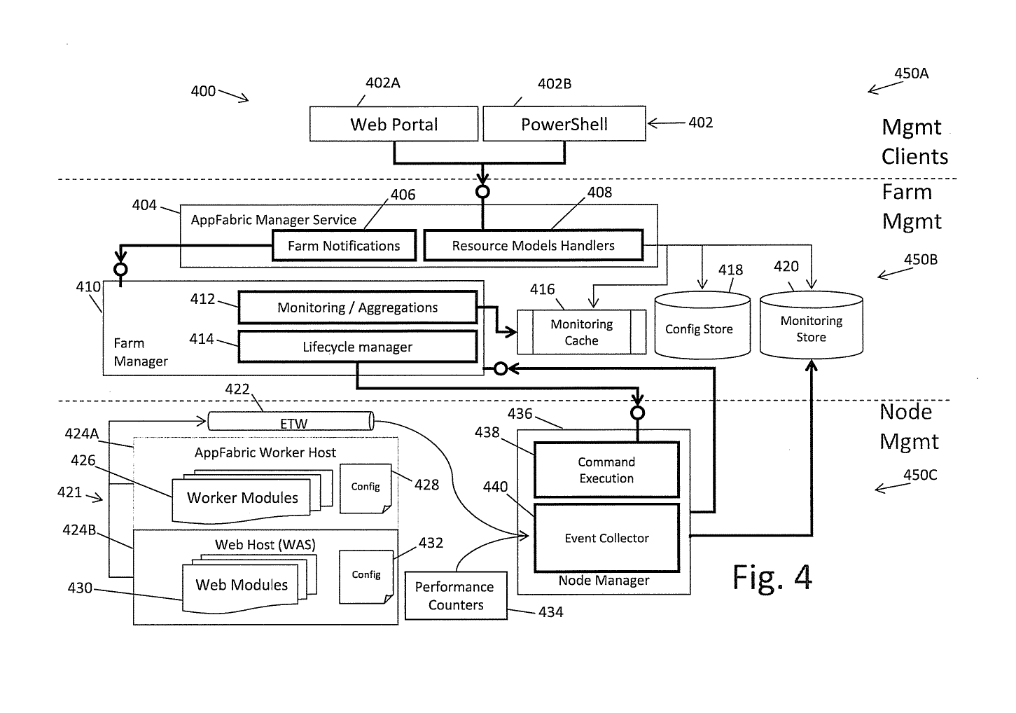

FIG. 4 is a block diagram illustrating a computer system architecture 400 that facilitates monitoring and managing distributed applications according to another embodiment. System 400 is divided into three levels 450A-450C. Level 450A of system 400 is a management clients level, and includes one or more management clients 402. Level 450B of system 400 is a farm management level, and includes manager service 404, farm manager 410, monitoring cache 416, configuration store 418, and monitoring store 420. Manager service 404 includes farm notifications unit 406 and resource models handlers 408. Farm manager 410 includes monitoring/aggregations unit 412 and lifecycle manager 414. Level 450C of system 400 is a node management level, and includes node 421. Node 421 includes event tracing for Windows (ETW) unit 422, worker host 424A, web host 424B, performance counters 434, and node manager 436. Worker host 424A includes a plurality of worker modules 426 and configuration information 428. Web host 424B includes a plurality of web modules 430 and configuration information 432. Node manager 436 includes command execution unit 438 and event collector 440.

Management clients level 450A represents the user interface to the system 400, and can include multiple clients 402, such as a web portal 402A and a set of powershell cmdlets 402B. The farm management level 450B includes a manager service 404, which is a web service that allows access to the functions of the system 400, and also includes configuration store 418 and monitoring store 420, which are persistent storage systems designed to save state information. Farm manager 410 is responsible for application management. Node management level 450C allows the system 400 to observe applications as they run, and also executes actions. Node manager 436 is responsible for node-level management functions. Node manager 436 is responsible for collecting various observations and allowing command execution on a given computer.

When a distributed application consumes one or more cloud services, it is typically difficult to centrally configure, command, control, monitor, and troubleshoot the application as a single unit. System 400 allows for configuring, commanding, controlling, monitoring, and troubleshooting such an application as a single unit, from one single location. System 400 according to one embodiment analyzes the current or predicted health of distributed applications. System 400 collects and monitors performance statistics, and predicts or forecasts performance statistics for distributed applications based on historical data. System 400 manages software-related state and configuration settings of distributed applications. In one embodiment, system 400 is also configured to accomplish the functions described above with respect to system 100 (FIG. 3).

System 400 according to one embodiment provides decentralized, highly scalable model-based application management, monitoring, and troubleshooting that allows: (1) Monitoring, by means of providing a real time metric acquisition and aggregation pipeline with several enhanced capabilities, and with this subsystem being capable of acquiring metrics on the client side (e.g., close to the consumption point of a service) as well as at the service side, by calling services' APIs to retrieve relevant metrics; (2) troubleshooting by effectively distributing and syndicating potentially highly verbose troubleshooting data; (3) managing state along various state dimensions (e.g., modeling, configuration, installation, runtime state, tenant, etc.) for both application and sub-application stateful entities (including aggregating state from sub-application entities); (4) resource traversal that allows applications to expose their custom entities alongside system entities (e.g., applications, modules, components); (5) on demand deployment of applications; (6) extensible user interface (UI) that allows a customer-provided application-specific UI to be automatically discovered and syndicated with; (7) asynchronous commanding (e.g. applications and application sub-entities) that can be conditional, scheduled, and policy-based; and (8) automatically generating a health and management model for a distributed application based on the application model.

The above features are accomplished in one embodiment in a manner that: (1) is highly distributed and decentralized with no single point of failure; (2) includes a management runtime that is decoupled from the application runtime; (3) is highly optimized for large scale by reducing overall resource consumption, including, but not limited to database access, network traffic, and CPU utilization; and (4) includes a hierarchical processing pipeline that is used to: (a) delegate as much work to nodes which are lower in the hierarchy so that resource requirements reduce as data travels up the hierarchy; (b) reduce volume of data passed up the hierarchy; (c) increase quality of data passed up the hierarchy (e.g., by means of re-aggregation). The above features and other features of system 400 will now be described in further detail.

System 400 is configured to roll up statistics for a modeled distributed application (e.g., application 40 shown in FIG. 2, application 107 shown in FIG. 3, or other distributed application) in a distributed managed system. System 400 performs an aggregation of metrics based on the application model, and collects and aggregate metrics at different scopes to give a single view for an application distributed to several nodes and/or services. System 400 uses the application model to determine which service(s) a given application consumes, and provides a hook in the interaction between the application and services for the purpose of monitoring. This allows the system 400 to calculate real time client side statistics about the application, and allows the system 400 to provide insight into how the application uses services, including, but not limited to, visibility in client side failures during service calls.

System 400 provides efficient farm-level monitoring. In one embodiment, system 400 uses a high performance tracing facility to extract events from running applications (e.g., the Windows kernel itself is instrumented via ETW 422). System 400 minimizes the amount of monitoring data sent from instances to the farm manager 410. The event collector 440 of node manager 436 performs aggressive aggregations of events at the node level. The node manager 436 batches these aggregations and submits them to farm manager 410 at scheduled intervals. In one embodiment, system 400 includes multiple nodes 421, and multiple node managers 436 that submit data to the farm manager 410 at randomized intervals. Event collector 440 can handle events generated from machines in different time zones, and in one embodiment, uses event timestamps UTC.

Monitoring/aggregations unit 412 in farm manager 410 performs a farm level aggregation (e.g., component, module, application) of the aggregations received from node manager 436, and stores the farm level metrics or aggregations in the monitoring cache 416. In one embodiment, for each farm level metric, only a predetermined number of data points are stored in cache 416. In one embodiment, farm manager 410 performs a hierarchical aggregation based on the application model.

Each aggregation performed by system 400 according to one embodiment condenses a large volume of raw events into a single aggregate event that summarizes the raw event stream. For example, if an IT professional wants to monitor the health of his or her Order Processing service, instead of viewing the raw durations for each service operation, which is extremely verbose, the IT professional can view the average call duration of the Order Processing service over one minute time windows, which would be computed by the manager service 404. These aggregations provide very concise and high value data about the running service.

Aggregation involves performing a temporal join over the input stream of events. Input events that belong to the same time window contribute to the same aggregation. In one embodiment, the temporal join is performed using a GroupBy key that uses the following tuple:

### (ResourceEvent.EventSource, ResourceEvent.InstanceId, ResourceEvent.TenantId, ResourceEvent.Dimensions).

System 400 includes an adaptive collection mechanism for real time monitoring in a distributed system. Network latency is inherent to distributed systems. Monitoring events travel over the network and in some systems may be discarded because it took longer for them to arrive than the aggregation time window. In one embodiment, real time metrics are collected by system 400 in a network latency resilient way. The events are collected in one embodiment during a sampling interval plus a delay period. The likelihood of real time monitoring events being discarded is reduced by first opening a time window (sampling interval) of t milliseconds during which system 400 acquires events. When the time window closes, the system 400 opens a delay period or grace period during which events running late will still be acquired and accounted for. The characteristics of the delay period are computed automatically by system 400 and adjusted based on events that come from various machines in the distributed system. The delay computation according to one embodiment is self-tuning based on event history. The system 400 uses past experience to refine this parameter, which leads to more accurate metrics, even in heavily loaded networks.

Monitoring/aggregations unit 412 issues output metrics when its internal clock (maintained per GroupBy key) advances past the expiration of the time window plus sonic configurable setting. The reason for the additional wait time is to mitigate out-of-order delivery of events. Once an output metric has been issued for a given time window, additional output for the same time window will not be issued (i.e., input events in the past are dropped). In one embodiment, the internal clock is advanced by using application time, meaning the timestamp contained in the input events. Monitoring/aggregations unit 412 spins up a background timer that periodically advances the internal clock (for all GroupBy keys) to mitigate the scenario where no further input events arrive.

System 400 is configured to project real time aggregated metrics using a current or partial (e.g., speculative) output. Typically, real time monitoring systems emit values at the end of each sampling interval. This may cause the observer of a metric to make decisions using data that does not accurately represent the state of the system at a given point in time. The current or partial output provided by system 400 according to one embodiment gives metrics observers visibility as metrics are collected before the sampling interval expires, offering a more accurate view of the system. Thus, system 400 does not wait for the time window to close before providing metrics, but rather provides speculative values for real time metrics, which are corrected later, if needed, based on new data.

In one embodiment, monitoring/aggregations unit 412 issues current or partial output metrics even if the time window has not expired. Speculative output metrics can be updated (i.e., Average/Count/Min/Max properties may be updated as future input events arrive). For current or partial output, MetricEvent.TimeWindow is set equal to TimeSpan.Zero. The scenario addressed by this feature is when there are large time windows (e.g., 10 minutes), but the user does not want to wait for the time window to expire before seeing output.

System 400 includes an efficient mechanism to troubleshoot transient errors in a distributed application. In one embodiment, troubleshooting information is retrieved at the time of failure of a modeled distributed application with a low application performance degradation. The point of failure can be any event, but is typically an exception emitted by application code. The retrieved troubleshooting information includes but is not limited to events on the failing component as well as events from related components. Troubleshooting information is cross-referenced with the application model information to facilitate error root cause analysis. The application model helps understand the relationships between different components related to the faulting component.

Troubleshooting is triggered on a failure or the satisfaction of a condition, and node manager 436 receives log files from hosts 424A and 424B. Node manager 436 store events triggered by errors in monitoring store 420. The error event and a predetermined number, K, of related events leading up the error are output by node manager 436. The logs are not only for the component that has an error, but are composed of logs from components in the request chain. The predetermined number, K, of events can be static or based on knowledge of the system (e.g., the number of nodes that the request spans as well as based on a requirement that a number, n, of events from each node is required to comprise the predetermined number, K, of events. For example, assume that the request sequence is A->B->C, and these components are running in a distributed system. A, B, and C are components that are part of the distributed application running on a single machine or different mollifies. If there is an error in C, the last K events that span A->B->C distributed across the different machines and components are triggered and stored. for diagnosing the transient error. Thus, system 400 is configured to capture logs for transient, hard-to-reproduce errors for components in a distributed system, where the log events for the transient error may need to be collected across various components running on different nodes, to troubleshoot the root cause of the problem. The error event (or any other trigger event) not only triggers the storing of log files on the faulting node, but also triggers the storing of log files on all related nodes and components involved in the request chain. Since the application is a model-based distributed application, it is possible to understand the dependencies between the various components, which helps in determining logs related to the trigger (e.g., faulting) node and all related nodes where the components run.

Management features of system 400 include: (1) A metadata store capable of storing developer's intent as well as a representation of the state of the real world; (2) detecting drift between the developer's intent and the real world along the various state dimensions by means of difference computation between records in the metadata store; (3) executing commands asynchronously on a distributed network of machines and collecting results out of band; (4) remediating drift when detected by means of asynchronous command execution; (5) controlling a plurality, n, of cloud services as a single unit; (6) supporting various levels of multi-tenancy management (e.g., Level 1—a primary customer of the invention; Level 2—Customers of the primary customer of the invention), including isolating application management, monitoring, and troubleshooting data from different customers; (7) deploying applications on demand; and (8) automatically generating a health and management model for a distributed application based on the application model. These and other management features of system 400 will now be described in further detail.

Distributed applications are managed by system 400 through a central console (e.g., management client 402). From a user's perspective, distributed applications being managed have a lifecycle. The lifecycle includes states, such as imported, deployed, running, or stopped. Applications transition from one state to another in response to commands issued to the system 400. For instance, the command “deploy app identifier=1” causes the system 400 to transition an application with identifier “1” from its current state to the “deployed” state. In response to this command, the system 400 performs actions to deploy the application. The following are some examples of such actions: (1) “copy application files like dynamic loaded libraries, executable, supporting files . . . to an adequate location on the file system”; and (2) “make the necessary configurations to the target computer to prepare for execution”.

System 400 has the ability to take a high level command like “deploy” and generate an ordered set of low level actions (typically 15 to 20). An example of a low level command is “copy file X to location Y” or “alter registry key X with value Y”. Management client 402 is used to submit a command order for a high level command to a service endpoint exposed by manager service 404. Manager service 404 saves the command order to persistent storage (e.g., configuration store 418, monitoring store 420, or other persistent storage) to maintain the order for future use, including audit trail and fault recovery. The farm manager 410 accesses the saved command order and coordinates command execution on a plurality of remote computers by talking to a web service on each and every target computer that is exposed by the node manager 436. More specifically, the lifecycle manager 414 calls one or more handlers to break down high-level commands into low-level commands. The handlers consult persistent storage (e.g., configuration store 418, monitoring store 420, or other persistent storage) to assist in determining which low level commands are to be run. The low-level commands are provided to node manager 436 for execution by command execution unit 438. Command execution is asynchronous and the farm manager 410 is resilient in the face of command failures. For instance, a command can be retrieved if it failed to produce a result in a given period of time. Farm manager 410 is able to send commands to many nodes 421 in parallel and monitor execution of those commands asynchronously.

System 400 is configured to operate on and manage various dimensions of the application (e.g., modeling, configuration, installation, runtime state, tenant, etc.). As the system 400 transitions applications through a lifecycle, the system 400 maintains information in persistent storage (e.g., configuration store 418 and monitoring store 420). This information according to one embodiment includes: (1) the intent expressed by the developer in the application model; (2) the observed state of applications, modules, and components, as well as related entities like computers on which applications run and containers running applications; (3) the effective configuration the application is currently using; (4) various observations related to application artifacts (e.g., including, but not limited to, version of dynamic loaded libraries, executable, hash of supporting files, last modified date/time, etc.).

System 400 makes use of this stored information to generate a list of low-level actions for a given command. System 400 is also capable of identifying discrepancies between the intent (stored as an application model in the persistent storage) and the observed state in the real world (“observations” stored in the database). This allows system 400 to detect deviations between intent and reality. These detections include but are not limited to: (1) component configuration drift; and (2) an application using a different version of a dynamic loaded library. When such a drift is detected, system 400 can perform corrective actions. For instance, an application may be Observed as “stopped” when the intent was to have it “started”. One kind of corrective action that can be performed by system 400 is to drive the application through its lifecycle. For instance, a stopped application can be brought to “started” by executing the “start” command. Another kind of corrective action is to bring the environment into conformance. For instance, if an application's dynamic loaded library is of a different version than what was intended, system 400 can generate an ordered set of low-level commands to bring the application back to the “genuine” state by overwriting the non-genuine dynamic loaded library with a genuine version of it and restarting the application appropriately.

System 400 may be used to import a new application. A user uses management client 402 to submit the application (e.g., application package) to a service endpoint exposed by manager service 404. This application package contains all the necessary artifacts to run the application, included but not limited to files, dlls, etc., as well as the model capturing the list of modules, components, and their metadata. Resource models handlers 408 then write the application to persistent storage (e.g., configuration store 418, monitoring store 420, or other persistent storage). Asynchronously, farm manager 410 reads the intent from the application model and saves it to the persistent storage in a format that is more readily consumable by the system 400.

System 400 according to one embodiment provides for optimal applications deployment by not actually copying applications' assets (binaries, . . . ) to every machine capable of running the application beforehand. Rather, upon an application's first request, the system 400 can deploy the adequate application's assets on a subset of the nodes. This on demand content delivery allows for a better usage of physical resources.

System 400 according to one embodiment has the ability to asynchronously execute commands against instances of the operating system, which makes it possible to automatically remediate drift.

In one embodiment, system 400 can interact with services consumed by the application to allow configuration, control and deployment of the application as a unit. For instance, a typical web application in the cloud uses a cloud database. System 400 is capable of interacting with the management endpoint of the cloud database and retrieve metrics pertinent to the database(s) used by the application.

Given a distributed application model and knowing the relationships and dependencies between various pieces, system 400 can generate a health and management model to monitor and troubleshoot the application. The health and management model can be consumed by tools such as Tivoli/SCOM, and can be superimposed on a visual representation of the application model. The generated health and management model contains information for managing and monitoring the components in the distributed application ranging from metrics to monitor the health, configuration metadata to manage and configure the components, as well as policies to manage the application such as policies for scalability, availability, and security. A generated health and management model allows a user to adorn an application model diagram with health information for the various components including information such as request flow between components, which is useful to walk back the component definition in case of errors. The health and management model allows defining downstream relationships between components of a distributed application, especially for dependent changes. For example, if throttle settings for requests per second change for a web page, then the knowledge that the web page calls a web service allows the health and management model to adjust the corresponding throttle settings on the web service automatically. The health and management model allows propagating related management settings between various pieces of the application, and allows troubleshooting various pieces together.

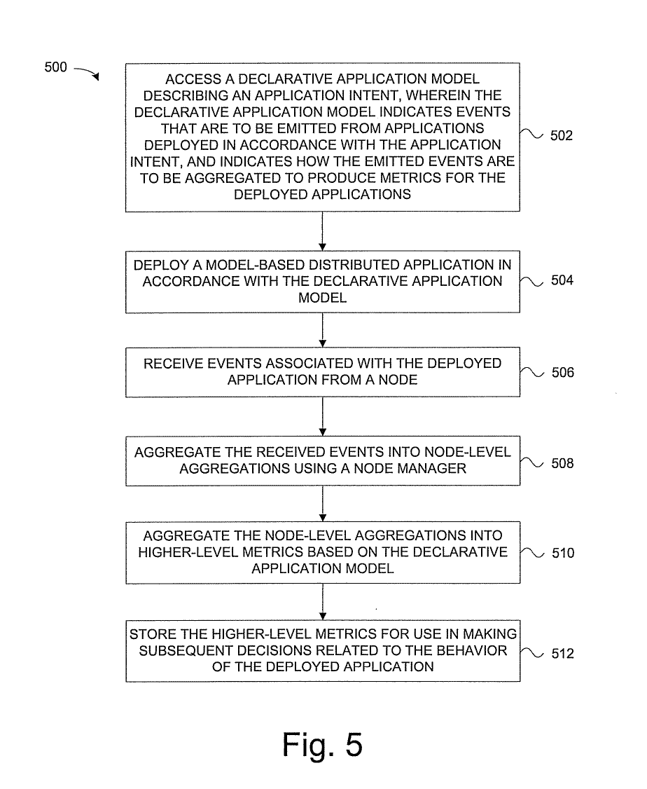

FIG. 5 is a flow diagram illustrating a method 500 for monitoring a model-based distributed application according to one embodiment. In one embodiment, system 100 (FIG. 3) or system 400 (FIG. 4) are configured to perform method 500. In another embodiment, aspects of systems 100 and 400 may he combined to perform method 500.

At 502 in method 500, a declarative application model describing an application intent is accessed, wherein the declarative application model indicates events that are to be emitted from applications deployed in accordance with the application intent, and indicates how the emitted events are to be aggregated to produce metrics for the deployed applications. At 504, a model-based distributed application is deployed in accordance with the declarative application model. At 506, events associated with the deployed application are received from a node. At 508, the received events are aggregated into node-level aggregations using a node manager. At 510, the node-level aggregations are aggregated into higher-level metrics based on the declarative application model. At 512, the higher-level metrics are stored for use in milking subsequent decisions related to the behavior of the deployed application.

In one embodiment of method 500, the accessing (502), deploying (504), receiving (506), aggregating (508 and 510), and storing (512) are performed by at least one processor. In one embodiment, method 500 also includes accessing the stored higher-level metrics, and comparing the higher-level metrics to the application intent described, in the declarative application model to determine if the deployed application is operating as intended. In one form of this embodiment, the method 500 also includes determining based on the comparison that the deployed application is not operating in accordance with the application intent, and modifying operation of the deployed application to more closely approach the application intent.

In one embodiment of method 500, a first one of the higher-level metrics is a real-time metric that is calculated based on events received during a sampling interval plus a variable delay period. In one form of this embodiment, the variable delay period is automatically adjusted based on event history. In another form of this embodiment, a current value for the first higher-level metric is output prior to completion of the sampling interval, and the current value for the first higher-level metric is updated after completion of the sampling interval.

Method 500 according to one embodiment also includes detecting a trigger event (e.g., a failure) in a first component of the deployed application, and storing events from the first component in response to the detected trigger event. Additional components related to the first component are identified based, on the declarative application model, Events from the additional components are stored in response to the detected trigger event. A cause of the trigger event is identified based on the stored events from the first component and the additional components.

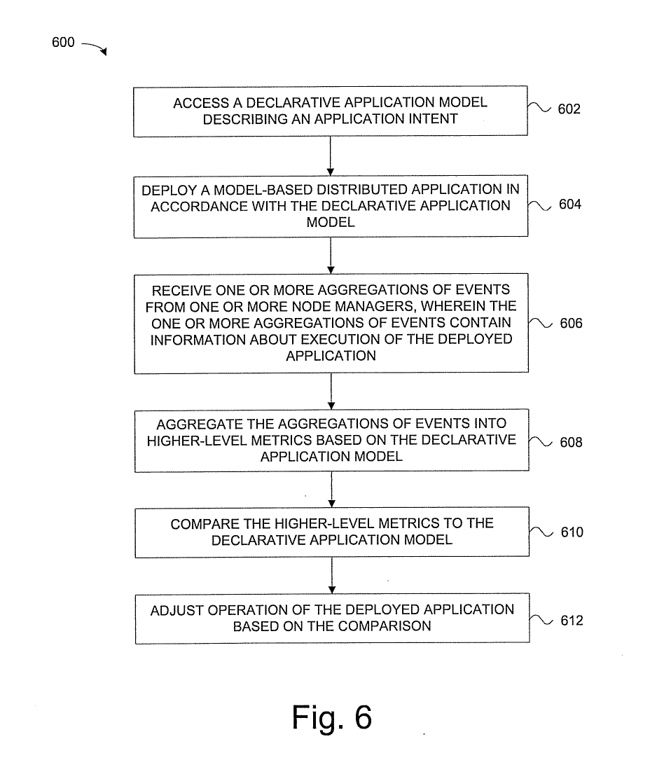

FIG. 6 is a flow diagram illustrating a method 600 for monitoring a model-based distributed application according to another embodiment. In one embodiment, system 100 (FIG. 3) or system 400 (FIG. 4) are configured to perform method 600. In another embodiment, aspects of systems 100 and 400 may be combined to perform method 600.

At 602 in method 600, a declarative application model describing an application intent is accessed. At 604, a model-based distributed application is deployed in accordance with the declarative application model. At 606, one or more aggregations of events are received from one or more node managers, wherein the one or more aggregations of events contain information about execution of the deployed application. At 608, the aggregations of events are aggregated into higher-level metrics based on the declarative application model. At 610, the higher-level metrics are compared to the declarative application model. At 612, operation of the deployed application is adjusted based on the comparison. In one embodiment of method 600, the accessing (602), deploying (604), receiving (606), aggregating (608), comparing (610), and adjusting (612) are performed by at least one processor.

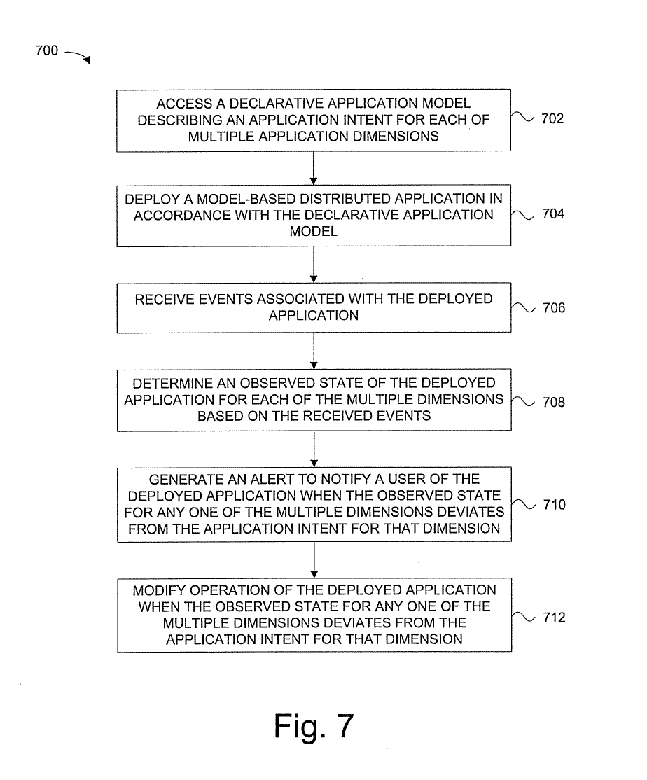

FIG. 7 is a flow diagram illustrating a method 700 for managing a model-based distributed application according to one embodiment. In one embodiment, system 100 (FIG. 3) or system 400 (FIG. 4) are configured to perform method 700. In another embodiment, aspects of systems 100 and 400 may be combined to perform method 700.

At 702 in method 700, a declarative application model describing an application intent for each of multiple application dimensions is accessed. At 704, a model-based distributed, application is deployed in accordance with the declarative application model. At 706, events associated with the deployed application are received. At 708, an observed state of the deployed application is determined for each of the multiple dimensions based on the received events. At 710, an alert to notify a user of the deployed application is generated when the observed state for any one of the multiple dimensions deviates from the application intent for that dimension. At 712, operation of the deployed application is modified when the observed state for any one of the multiple dimensions deviates from the application intent for that dimension.

In one embodiment of method 700, the accessing (702), deploying (704), receiving (706), determining (708), generating (710), and modifying (712) are performed by at least one processor. The multiple dimensions in method 700 according to one embodiment include modeling, configuration, installation, runtime, and tenancy, wherein tenancy indicates a primary customer of the deployed application, and customers of the primary customer. In one embodiment, method 700 further includes isolating customer-specific management, information for each customer from other customers.

In one embodiment of method 700, the events are received from a first node by a node manager, and the received events are aggregated into node-level aggregations using the node manager. In one form of this embodiment, the node-level aggregations are aggregated into higher-level metrics based on the declarative application model, and the higher-level metrics are compared to the application intent for each of the multiple dimensions to determine if the deployed application is operating as intended. Method 700 according to one embodiment includes automatically generating a health and management model for the deployed application based on the application model to facilitate management of the deployed application.

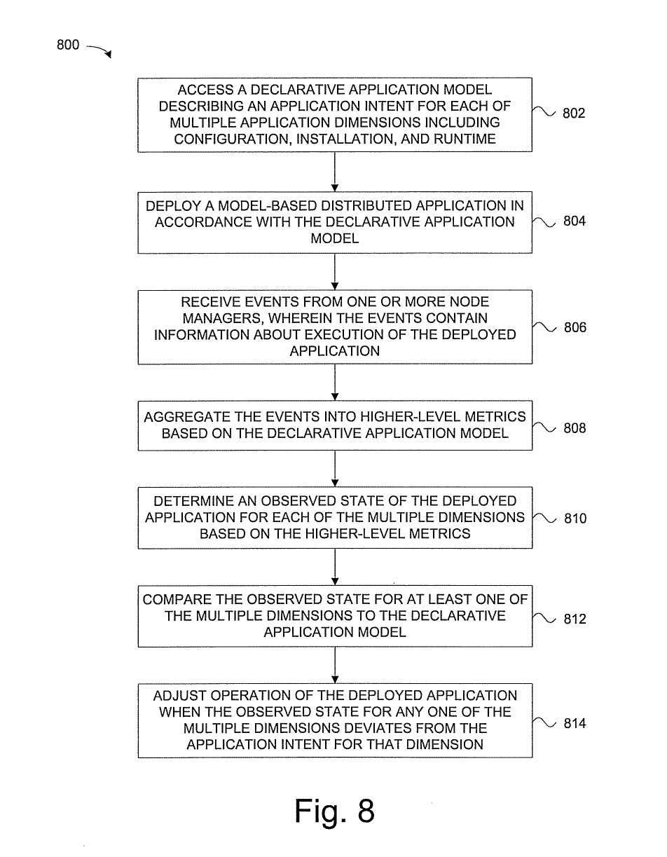

FIG. 8 is a flow diagram illustrating a method 800 for managing a model-based distributed application according to another embodiment. In one embodiment, system 100 (FIG. 3) or system 400 (FIG. 4) are configured to perform method 800. In another embodiment, aspects of systems 100 and 400 may be combined to perform method 800.

At 802 in method 800, a declarative application model describing an application intent for each of multiple application dimensions including configuration, installation, and runtime, is accessed. At 804, a model-based distributed application in accordance with the declarative application model is deployed. At 806, events from one or more node managers are received, wherein the events contain information about execution of the deployed. application. At 808, the events are aggregated into higher-level metrics based on the declarative application model. At 810, an observed state of the deployed application is determined for each of the multiple dimensions based on the higher-level metrics. At 812, the observed state for at least one of the multiple dimensions is compared to the declarative application model. At 814, operation of the deployed application is adjusted when the observed state for any one of the multiple dimensions deviates from the application intent for that dimension.

In one embodiment of method 800, the accessing (802), deploying (804), receiving (806), aggregating (808), determining (810), compiling (812), and adjusting (814) are performed by at least one processor. The multiple dimensions in method 800 according to one embodiment further include modeling and tenancy, wherein tenancy indicates a primary customer of the deployed application, and customers of the primary customer. In one embodiment, method 800 further includes isolating customer-specific management information for each customer from other customers.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method for managing a model-based distributed application, the method comprising:
accessing a declarative application model describing an application intent for each of multiple application dimensions;
deploying a model-based distributed application in accordance with the declarative application model;
receiving events associated with the deployed application;
determining an observed state of the deployed application for each of the multiple dimensions based on the received events; and
modifying operation of the deployed application when the observed state for any one of the multiple dimensions deviates from the application intent for that dimension.

2. The method of claim 1, wherein the accessing, deploying, receiving, determining, and modifying are performed by at least one processor.

3. The method of claim 1, wherein the multiple dimensions include configuration, installation, and runtime.

4. The method of claim 3, wherein the multiple dimensions further include modeling.

5. The method of claim 4, wherein the multiple dimensions further include tenancy, and wherein tenancy indicates a primary customer of the deployed application, and customers of the primary customer, and wherein the method further comprises:
isolating customer-specific management information for each customer from other customers.

6. The method of claim 1, and further comprising:
generating an alert to notify a user of the deployed application when the observed state for any one of the multiple dimensions deviates from the application intent for that dimension.

7. The method of claim 1, wherein the events are received from a first node by a node manager, and wherein the method further comprises:
aggregating the received events into node-level aggregations using the node manager.

8. The method of claim 7, and further comprising:
aggregating the node-level aggregations into higher-level metrics based on the declarative application model.

9. The method of claim 8, and further comprising:
comparing the higher-level metrics to the application intent for each of the multiple dimensions to determine if the deployed application is operating as intended.

10. The method of claim 1, and further comprising:
automatically generating a health and management model for the deployed application based on the application model to facilitate management of the deployed application.

11. A computer-readable storage medium storing computer-executable instructions that when executed by at least one processor cause the at least one processor to perform a method for managing a model-based distributed application, the method comprising:
accessing a declarative application model describing an application intent for each of multiple application dimensions including configuration, installation, and runtime;
deploying a model-based distributed application in accordance with the declarative application model;
receiving events associated with the deployed application;
determining an observed state of the deployed application for each of the multiple dimensions based on the received events; and
modifying operation of the deployed application when the observed state for any one of the multiple dimensions deviates from the application intent for that dimension.

12. The computer-readable storage medium of claim 11, wherein the multiple dimensions further include modeling.

13. The computer-readable storage medium of claim 12, wherein the multiple dimensions further include tenancy, and wherein tenancy indicates a primary customer of the deployed application, and customers of the primary customer, and wherein the method further comprises:
isolating customer-specific management information for each customer from other customers.

14. The computer-readable storage medium of claim 11, wherein the method further comprises:
generating an alert to notify a user of the deployed application when the observed state for any one of the multiple dimensions deviates from the application intent for that dimension.

15. The computer-readable storage medium of claim 11, wherein the events are received from a first node by a node manager, and wherein the method further comprises:
aggregating the received events into node-level aggregations using the node manager.

16. The computer-readable storage medium of claim 15, wherein the method further comprises:
aggregating the node-level aggregations into higher-level metrics based on the declarative application model.

17. The computer-readable storage medium of claim 16, wherein the method further comprises:
comparing the higher-level metrics to the application intent for each of the multiple dimensions to determine if the deployed application is operating as intended.

18. The computer-readable storage medium of claim 11, wherein the method further comprises:
automatically generating a health and management model for the deployed application based on the application model to facilitate management of the deployed application.

19. A method for managing a model-based distributed application, the method comprising:
accessing a declarative application model describing an application intent for each of multiple application dimensions including configuration, installation, and runtime;
deploying a model-based distributed application in accordance with the declarative application model;
receiving events from one or more node managers, the events containing information about execution of the deployed application;
aggregating the events into higher-level metrics based on the declarative application model;
determining an observed state of the deployed application for each of the multiple dimensions based on the higher-level metrics;
comparing the observed state for at least one of the multiple dimensions to the declarative application model;
adjusting operation of the deployed application when the observed state for any one of the multiple dimensions deviates from the application intent for that dimension; and
wherein the accessing, deploying, receiving, aggregating, determining, comparing, and adjusting are performed by at least one processor.

20. The method of claim 19, wherein the multiple dimensions further include modeling and tenancy, and wherein tenancy indicates a primary customer of the deployed application, and customers of the primary customer.
